(19) United States
(12) Patent Application Publication
(10) Pub. No.: US 2008/0194735 A1
(43) Pub. Date: Aug. 14, 2008

(54) Polymeric Resin Composition For the Production of Coatings

(76) Inventors: Jose Angel Verdugo-Perez, Ocoyoacac (MX); Jose Alberto Castillo-Hernandez, Ocoyacac (MX)

Correspondence Address: BROWDY AND NEIMARK, P.L.L.C.;624 NINTH STREET, NW, SUITE 300, WASHINGTON, DC, 20001-5303, US

(21) Appl. No.: 11/631,001

(22) PCT Filed: Jun. 28, 2004
(86) PCT No.: PCT/IB04/02160

§ 371 Date: Sep. 25, 2007

(51) Int. Cl. C04B 28/00; C08L 75/04; C08K 3/00

(52) U.S. Cl. 524/4; 525/125; 524/507; 524/366; 524/347; 524/352

(57) ABSTRACT

Disclosed herein is a resin composition for the manufacture of coatings such as polymeric concretes, terrazzos and finishes, comprising: a) from 15 to 50% by weight of methyl methacrylate (MMA) monomer; b) from 25 to 75% by weight of a mixture of equal parts of polyester resins of: i) an isophthalic polyester resin; ii) an orthophthalic polyester resin; and iii) a neopentyl polyester resin; c) up to 8% by weight of an epoxy resin obtained from bisphenol A and epichlorohydrin; and d) up to 5% by weight of an aliphatic or aromatic polyurethane resin.

### FIELD OF THE INVENTION

The present invention relates to the techniques employed in the manufacture of coatings and, specifically, to a polymeric resin composition for the manufacture of concrete, terrazzos and finishes that are used to coat surfaces, preferably industrial floors.

### BACKGROUND OF THE INVENTION

In several locations where diverse human activities take place, mainly of an industrial nature, floor surfaces are constantly exposed to damages for several reasons, such as the mechanical action of pieces of equipment and working vehicles, as well as of he operating staff; chemical action of substances; environmental actions, and so on. For this reason, floors that are usually with slabs and plates made of hydraulic concrete pose various problems over time, among which cracking, surface wear-out, deterioration of joints (where two floor plates connect), displacement of plates, fouling, surface crimping, impregnation of various substances, mainly grease and oil, growth of microorganisms, and so on.

With the aim of reducing or, in the best case scenario, preventing the arise of issues hereinabove, application of different types of coatings is known in the art which, in addition to providing such protective feature, also provide an aesthetic look to the floor. Among these, polymeric coatings formulated with epoxy, polyurethane, polyester or acrylic resins are found, which are applied individually or mixed with inorganic fillers, in such a way that when resins harden or set they form a coating that protects the surface against the action of the above agents.

In this regard, it is important to point out that the coating may be made either with a polymeric finish formulated exclusively with resins or a multilayer system, depending on the degree of protection required or intended for a particular surface or substrate. A multilayer system may include a primer layer, an intermediate layer of polymeric concrete and a finish layer, out of which, the polymeric concrete is made from a mixture comprising a polymeric resin and sand and calcium carbonate fillers or other minerals.

Furthermore, in applications where, in addition to the protective action of the coating, an aesthetic appearance is sought, use is made of polymeric terrazzos, which are manufactured from a mix of polymeric resins and particles or granules of marble, quartz, and so on. After a polishing operation on the coating made from such mix, the added particles noticeably stand out, thereby achieving a coating with a texture similar to that of a conventional terrazzo in which particles are distributed over a cement matrix.

On the other hand, it is important to note that polymeric concretes, terrazzos and finishes essentially comprise one type of resin, whether from acrylic, epoxy, polyester or urethane, each of the latter being catalyzed by the respective catalyst. Nevertheless, although such resins are widely used in the art, they pose disadvantages and issues when employed to coat surfaces, such issues being the following:

Slow reaction or hardening times—the resins known from the prior art for the manufacture of polymeric concretes, terrazzos or finishes typically become hard or polymerize within a period of time from 6 to 24 hours, which is a problem for those industrial facilities running around the clock, because if applying a coating is desired, a total shutdown is needed throughout the plant, something that cannot be possible in all instances.

Cutting of joints—since most of the floors are formed by concrete plates or slabs, an additional problem arises concerning the cutting of joints thereof, because when coatings made with prior art resins harden; cuts are needed on the surface formed to allow for the expansion and contraction along with the movement of slabs found underneath them, the consequence of which is dust that pollutes the environment and the time consumed by such cutting process.

Loss of luster—when polymeric concrete, terrazzo or finish have hardened, they lose their initial luster over time. To date, prior art resins do not allow the manufacture of a coating that can be brightened or polished once applied.

Maintenance difficulty—no resin composition known to date can be applied on a preexistent and already damaged or worn out polymeric coating, which is inconvenient whenever such coating needs to be repaired. In this particular case, the traditional manner of repairing the polymeric coating is to perform a sanding operation on the worn out coating so as to apply the new one. In addition to the dust created, a drawback is that the new coating is just attached to the worn out one by means of a physical anchorage, which does not ensure long-term duration because small fragments may come off from the coating due to use. This issue is referred to in the field of coatings as “delamination”.

Burns—conventional polymeric coatings manufactured from acrylic resins undergo significant deterioration when a forklift suddenly halts or slides, since the friction of rubber tires against the polymeric coating raises the temperature of the latter, thereby leaving burning marks from the interaction between rubber of tires and resin from the coating.

Application temperature—polymeric concretes, terrazzos and finishes manufactured from polyester, epoxy or urethane resins only harden when temperature is above 3° C. This fact poses an issue, particularly at those locations where ambient temperature in winter is below 3° C., thereby preventing the application of any polymeric coating.

Steep application expenses—since the setting times of polymeric coatings found in the prior art are slow, the staff hired to apply the coating has to be present for a long time, which may encompass several days.

Poor outdoor strength—epoxy- or urethane-based coatings, mainly finishes, are poorly resistant to outdoor conditions; they are particularly sensitive to the sun's UV rays, which deprive them from durability, color and luster. Typically, coatings made of these types of resins have a maximum life of 3 years.

Regarding the above, in an effort to cut down on setting times of polymeric resin-based coatings, one of the inventors of the present patent application performed tests with an acrylic resin to manufacture polymeric finishes and concretes, as well as compositions to fill holes (“pothole compositions”), said resin featuring a setting time of between 15 and 60 minutes, which is substantially reduced in comparison with known resins of that time. This acrylic type resin is disclosed in Mexican Patent Applications No. 9207042, 9207043, 9207044, 9207045, 9207046 and 9207048, all of which are currently abandoned as the inventor considered the same were lacking a clear description to understand the invention.

More specifically, the resin of the above applications is composed of: i) methyl methacrylate monomer (MMA) in about 88% by weight from the total weight of the composition; ii) N-N-dimethyl aniline and/or dimethyl paratoluidine in about 2% by weight from the total weight of the composition; hydroquinone methyl ether and/or dibutyl paracresol in about 0.06% by weight from the total weight of the composition; iv) dibutyl phthalate in about 4.0% by weight from the total weight of the composition; and v) ethylene glycol dimethacrylate and/or hexamethoxy methyl melamine in about 6% by weight from the total weight of the composition.

Notwithstanding that the acrylic resin referred to in the above Mexican applications have lower setting times, coatings manufactured therewith have the disadvantage that cutting of their joints is required, not to mention that such resin has to be applied directly on a worn-out coating; i.e., a sanding operation is needed in order to apply the resin, thereby raising dust and time delays throughout application thereof, as previously mentioned.

In accordance ut supra, efforts have been conducted in order to circumvent the drawbacks of prior art polymeric resins employed in the coating of surfaces, preferably industrial floors, through the development of a resin composition for the manufacture of coatings such as concretes, terrazzos and finishes that, in addition to a substantially lower setting time versus prior art resins, prevents the cutting of joints once the coating has been applied, the resin composition of the present invention also allowing its application on damaged coatings since it has the advantage of chemically attach thereto. Coatings made from the resin composition can be polished repeatedly to keep their luster.

### SUMMARY AND OBJECTS OF THE INVENTION

Bearing in mind the inconveniences of compositions found in the state of the art, it is an object of the present invention to provide a polymeric resin composition for the manufacture of coatings with a setting time that is substantially lower versus resins employed in the prior art, said polymeric resin composition being highly efficient in achieving a coating that prevents premature wear-out of surfaces due to environmental reasons or movement of pieces of equipment and working vehicles.

It is another object of the invention to provide a polymeric resin composition for the manufacture of coatings such as polymeric concretes, terrazzos and finishes that can be applied on any surface, with preference given to industrial floors.

A further object of the invention is to provide a polymeric resin composition for the manufacture of coatings that can be applied on a preexistent polymeric coating, thereby creating an efficient chemical attachment between both coatings and, therefore, allowing cost and maintenance savings.

Still another object of the present invention is to provide a polymeric resin composition for the manufacture of coatings that prevents the cutting of joints of the coating formed from the composition.

It is still a further object of the present invention to provide a polymeric resin composition for the manufacture of coatings that allow setting thereof at substantially low temperatures.

It is still a further object of the present invention to provide a polymeric resin composition for the manufacture of coatings that can be polished and/or brightened as many times as necessary.

### BRIEF DESCRIPTION OF THE DRAWINGS

The novelty aspects encompassed by the present invention shall be set forth in the appended claims. However, the invention itself, both its composition as well as its application method, along with other objects and advantages thereof, shall be better understood from the following detailed description of certain embodiments, when read in relation to the accompanying drawing, in which,

FIG. 1 is an enlarged elevated side view of a cross section of a concrete slab on top of which a multilayer polymeric coating has been applied, each one of the layers was obtained from the polymeric resin composition of the present invention.

### DETAILED DESCRIPTION OF THE INVENTION

It has been found that when acrylic-, polyester-, epoxy- and polyurethane-based polymeric resins are mixed in certain ratios, polymeric coatings such as polymeric concretes, terrazzos and finishes are achieved which performance is substantially higher in comparison with coatings formulated with polymeric resins of the prior art.

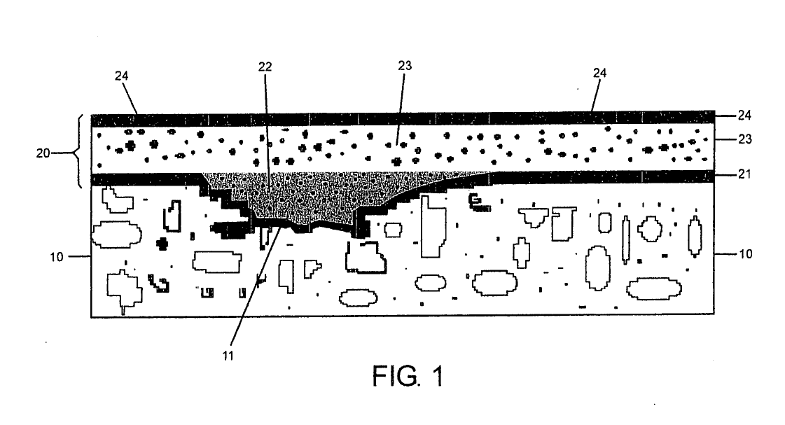

In order to facilitate comprehension of and clarify the field of application of the polymeric resin composition of the present invention, reference is made to FIG. 1 which shows a concrete slab 10 in cross section over which a polymeric coating 20 has been applied thereto, which is formed by a layer system that comprises: a primer layer 21 applied directly on the slab 10; a pothole composition layer 22 to fill a cavity 11 that developed gradually due to the concrete slab 10 wear-out; a polymeric concrete layer 23 applied on top of the pothole composition layer 22; and finally, a finishing layer 24 formed on the polymeric concrete 23, which can be perceived by anyone walking on the coating. It is important to point out that each of the layers forming said polymeric coating 20 is formulated with the resin composition of the present invention.

Likewise, for clarification purposes, it is also noteworthy that, concerning polymeric resins as it is known to those skilled in the art, polyester resins are made from the reaction of dibasic organic acids and glycols and, therefore, an isophthalic polyester resin shall be understood hereinafter as that wherein its organic acid units come from isophthalic acid, whereas an orthophthalic polyester resin comes from orthophthalic acid, and a neopentyl polyester resin derives from a neopentyl glycol.

On the other hand, polyurethane resins are formed from the reaction of polyhydroxy compounds (typically glycols) with a di-functional isocyanate, wherein the NCO groups can be attached to an aromatic or aliphatic backbone and, thus, polyurethane resins are classified as aromatic or aliphatic in accordance with the nature of the isocyanate being employed.

Now, in a particular embodiment of the present invention, a polymeric resin composition is disclosed for the manufacture of coatings such as polymeric concretes, terrazzos and finishes to be applied on industrial floors, this embodiment should be deemed as illustrative and not restrictive of the present invention, the particular embodiment comprises:
(a) from about 15 to about 50% by weight of methyl methacrylate (MMA) monomer;
(b) from about 25 to about 75% by weight of a mixture of equal parts of: an isophthalic polyester resin; an orthophthalic polyester resin; and a neopentyl polyester resin;
(c) up to about 8% by weight of an epoxy resin obtained from bisphenol A and epichlorohydrin; and,
(d) up to about 5% by weight of an aliphatic or aromatic polyurethane resin.

The resin composition mentioned above is mainly featured by the use of four types of resins, out of which the polyester resin mixture is found in a high weight percentage in the composition. With the polymeric resin composition of the present invention coatings such as polymeric concretes, terrazzos and finishes are manufactured, their performance being noticeably better from the moment they are applied on the surface of substrate to be coated, as well as their service life versus similar prior art coatings.

In addition to such basic resins, the composition of the present invention preferably comprises other agents and compounds to improve its performance. More particularly, in a first alternative embodiment of the present invention, the polymeric resin composition further comprises at least one of the following agents or compounds:
(e) from about 1 to about 2% by weight of a polymerization promoter of methacrylic monomers, such promoter being selected from the group of compounds consisting of N,N-dimethyl-paratoluidine (DMPT), dimethylaniline (DMA), or a mixture thereof;
(f) from about 0.05 to about 0.5% by weight of an inhibitor or stabilizer selected from the group of compounds consisting of hydroquinone methyl ether, hydroquinone (HQ), dibutyl paracresol or a mixture thereof;
(g) from about 0.1 to about 0.5% by weight of a polymerization promoter or activator of polyester resins, said promoter being selected from the group of compounds consisting of cobalt naphthenate, cobalt octoate or a mixture thereof; and
(h) up to about 1.5% by weight of paraffin that functions as an oxidation inhibitor for the composition when in contact with the environment.

The composition may comprise other agents based on the end use of the resin composition of the present invention; i.e., whether as a primer, as a polymeric concrete or terrazzo or as a finish, as shown in FIG. 1. For instance, when the resin composition is used for manufacturing polymeric finishes, the latter may additionally comprise at least one of the following agents or compounds:
(i) from about 5 to about 12% by weight of viscosity enhancers, such enhancer being selected from styrene and/or methyl methacrylate monomer.
(j) from about 3 to about 10% by weight of a UV-ray protective compound, such compound being selected from the group of compounds consisting of dibutyl maleate, benzophenone or a mixture thereof.
(k) up to about 8% by weight of ethylene glycol dimethacrylate; and
(l) up to about 5% by weight of pigments.

In order to solve one of the main problems of the prior art, particularly the repairing of worn-out coatings, the authors of the present invention have surprisingly found that when the composition of the present invention additionally comprises: m) from about 3 to about 5% by weight of 2-hydroxypropyl-methacrylate, a polymeric finish is achieved that chemically attaches to worn-out and damaged coatings of any kind, surprisingly including epoxy or polyurethane type coatings. In other words, when the composition of the present invention includes said compound, a composition compatible with any polymeric coating system is achieved.

On the other hand, in order to begin the polymerization process of the resin composition of the present invention, benzoyl peroxide (BOP), methyl ethyl ketone (MEK) or a mixture thereof are employed as catalysts; particularly, for catalyzing the resin composition a by weight ratio between the catalyst and the resin composition ranging from about 0.02:1 to about 0.05:1 (catalyst/resin composition) is employed.

The viscosity of the polymeric resin composition of the present invention measured with a Ford No. 4 cup is in the range from about 8 to about 40 seconds, which allows it to be handled and applied in a practical and easy manner and has a setting time of 0.5 to 2.0 hours.

When the resin composition of the present invention is employed to manufacture a polymeric concrete or terrazzo, the resin composition is mixture with mineral fillers or plastic material fillers, such that from that mixture the said polymeric concrete or terrazzo is obtained. Preferably, minerals fillers such as silica sands, calcium carbonate, silicon carbide, marble particles, glass, quartz, or a mixture thereof are employed. In a preferred embodiment, the mineral or plastic filler weight ratio to the resin composition to manufacture the polymeric concrete or terrazzo is within the range from 2:1 to about 6:1 (fillers/resin composition).

More particularly, when such fillers are of a mineral nature, particles are employed with particle size of from about 45 μm to about 4 mm. Specifically, when the resin composition is used to manufacture a polymeric terrazzo, marble, glass or quartz particles or a mixture thereof are used as fillers, with a preferred particle size from about 45 μm to about 3 mm.

The resin composition of the present invention for the manufacture of coatings such as polymeric concretes, terrazzos and finishes will be more clearly understood via the examples hereinbelow which are provided for illustrative purposes only and therefore do not restrict the invention.

### EXAMPLE 1

### Formation of a Coating System Including a Polymeric Concrete Layer and a Finish Layer

A polymeric coating constituted by a primer layer; a pothole composition layer; a polymeric concrete and a finish was formed on a 30 m² surface concrete floor in an industrial facility. Said floor was made of squared concrete slabs with cracks and cavities visible to the naked eye. Additionally, joints between slabs were notoriously worn out.

In order to form each one of the polymeric coating layers by use of the resin composition of the present invention, the concrete surface was initially cleaned and prepared with a shot blast, which rendered the floor surface a rough and clean texture in order to apply the primer layer as the initial layer.

The resin composition used for the primer is shown in Table 1.

TABLE 1
Resin composition for the primer layer

| COMPONENT | WEIGHT % |
|---|---|
| Methyl methacrylate (MMA) monomer | 47.5 |
| Mixture of equal parts of polyester | 47.5 |
| resins | |
| Epoxy resin | 1.5 |
| Aliphatic polyurethane resin | 1.5 |
| N-N,dimethyl-paratoluidine | 1.8 |
| Paraffin | 0.2 |
| Total | 100 |

All the components were mixed thoroughly with an electromechanical agitator and benzoyl peroxide in an amount equal to 5% from the total weight of the resin composition of table 1 was added during the stirring step. The resulting mixture was applied on the floor at an ambient temperature of 18° C., with the primer layer drying in 0.5 hours.

Thereafter, the cracks and joints from the concrete slabs were covered with a cavity filling composition (“pothole composition”) which was obtained by mixing 1) the resin composition of the present invention; and 2) silica sands and calcium carbonate fillers, with a particle size from 45 μm to about 1 mm. The filler to resin ratio was 3:1.

Particularly, the resin composition used in the pothole mixture is shown in table 2:

TABLE 2
Resin composition for filling cavities

| COMPONENT | WEIGHT % |
|---|---|
| Methyl methacrylate (MMA) monomer | 47.5 |
| Mixture of equal parts of polyester | 50 |
| resins | |
| N-N,dimethyl-paratoluidine | 1.8 |
| Paraffin | 0.7 |
| Total | 100 |

All the components were mixed thoroughly with an electromechanical agitator and benzoyl peroxide in an amount equal to 5% from the total weight of the resin composition of table 2 was added during the stirring step simultaneously with the fillers mentioned above. The resulting mixture was applied on the floor cavities pre-covered with the primer layer. The temperature of application was 18° C., with the pothole composition primer layer setting in 0.5 hours.

Thereafter, a layer of polymeric concrete was applied on top of the primer and the pothole composition, the polymeric concrete layer being achieved by mixing: 1) the resin composition of the present invention; and 2) silica sand and carbonate fillers with a particle size of 45 μm to 180 μm, in a 3:1 filler to resin weight ratio.

Regarding the polymeric concrete, the resin composition employed was that mentioned in table 3 below.

TABLE 3
Resin composition used for the polymeric concrete

| COMPONENT | WEIGHT % |
|---|---|
| Methyl methacrylate (MMA) monomer | 47.5 |
| Mixture of equal parts of polyester | 46.5 |
| resins | |
| Epoxy resin | 4.0 |
| N-N,dimethyl-paratoluidine | 1.8 |
| Paraffin | 0.2 |
| Total | 100 |

All the components were mixed thoroughly with an electromechanical agitator and benzoyl peroxide in an amount equal to 5% from the total weight of the resin composition of table 3 was added during the stirring step, simultaneously with the fillers mentioned above. The temperature of application of the polymeric concrete mixture was 18° C., its setting time being of 0.5 hours.

Finally, a finish employing the resin of the present invention was applied on the polymeric concrete layer, the specific composition for the layer being that shown in table 4.

TABLE 4
Resin composition for the finish layer

| COMPONENT | WEIGHT % |
|---|---|
| Methyl methacrylate (MMA) monomer | 18.6 |
| Mixture of equal parts of polyester | 60.0 |
| resins | |
| Dibutyl maleate | 4.3 |
| 2-hydroxypropyl methacrylate | 5.0 |
| N-N,dimethyl-paratoluidine | 1.6 |
| Styrene monomer | 5.5 |
| Pigments | 5.0 |
| Total | 100 |

The above mixture was mixed thoroughly and benzoyl peroxide in an amount equal to 5% from the total weight of the resin composition of table 4 was added simultaneously. The resulting mixture was applied on the already set concrete, the ambient temperature was of 18° C., thereby achieving a setting time of 0.65 hours for the finish.

The polymeric coating thus formed had a nice look, with a flat surface that facilitated the transit of people and forklifts.

### EXAMPLE 2

### Formation of a Polymeric Terrazzo

A polymeric terrazzo was made on a 5-year old concrete floor and a general good appearance, which nevertheless was used to improve its aesthetic look. The floor surface covered was 12 m².

In order to make the terrazzo, a series of steps were followed starting with preparation of the floor (substrate) with a road scraper, thereby achieving a rough, dry and clean surface. Afterwards, 4 Kg. of a resin composition from the present invention were prepared for use as a primer on the clean surface. The primer composition in particular was that shown in table 5 below.

TABLE 5
Resin composition for the primer layer

| COMPONENT | WEIGHT % |
|---|---|
| Methyl methacrylate (MMA) monomer | 47.63% |
| Mixture of equal parts of polyester | 50.13% |
| resins | |
| Dimethyl aniline and/or N,N-dimethyl | 1.25% |
| paratoluidine mixture | |
| Dibutyl-paracresol and hydroquinone | 0.09% |
| mixture | |
| Paraffin | 0.90% |
| Total | 100 |

All the components from table 5 were mixed thoroughly with an electromechanical agitator and benzoyl peroxide in an amount equal to 3% from the total weight of the resin was added during the mixing. The resulting mixture was applied on the prepared surface with a felt roller. Drying time was 30 minutes with an ambient temperature of 20° C.

Thereafter, 27.5 Kg. of a mixture to make the polymeric terrazzo with the resin composition of the present invention plus marble particle fillers were prepared. The resin composition and marble fillers employed for such purpose are shown in tables 6 and 7 below.

TABLE 6
Resin composition for the polymeric terrazzo

| COMPONENT | WEIGHT % |
|---|---|
| Methyl methacrylate (MMA) monomer | 21.64 |
| Mixture of equal parts of polyester | 69.50 |
| resins | |
| Dimethyl aniline and/or N,N-dimethyl | 0.60 |
| paratoluidyne mixture | |
| Dibutyl-paracresol and hydroquinone | 0.05% |
| mixture | |
| Dibutyl maleate and benzophenone | 3.00 |
| mixture | |
| Pigments (titanium dioxide and black | 4.35 |
| color paste) | |
| Paraffin | 0.86 |
| Total | 100 |

TABLE 7
Filler composition for the polymeric terrazzo

| COMPONENT | WEIGHT % |
|---|---|
| Marble grain No. 2 white (average size | 42.03 |
| 3 mm) | |
| Marble grain No. 1 dark gray (average | 34.78 |
| size 1 mm) | |
| Fine thin marble grain dust (average | 23.19 |
| size 0.3 mm) | |
| Total | 100 |

All the components from tables 6 and 7 were mixed thoroughly to a homogeneous mixture, and methyl ethyl ketone was added simultaneously in an amount equal to 4% by total weight of the resin composition of table 6. Also, the filler to resin composition weight ratio was 6:1. The resulting mixture was applied manually with a trowel on the primer layer of the floor. The terrazzo dried in 2 hours at 20° C.

Once the terrazzo dried out, a polishing operation was performed with a three-phased, two-head electric polisher each head provided with three, grade 24 grinders; throughout this operation, water was used to avoid dusting. Once the operator perceived the marble grains on the terrazzo, the grinder were changed by grad 80 grinders and afterwards grade 200 grinders.

Upon polishing, a terrazzo brightening operation was performed with a commercially available oxalic acid-based paste and ixtle pieces on the polisher heads, after which the entire surface was washed with soap and water.

The polymeric terrazzo thus formed had a speckled glossy appearance that improves the physical and chemical strength of concrete slabs. The installation time of this terrazzo was essentially lower in comparison with other polymeric terrazzo systems; e.g., an epoxy resin-based terrazzo applied on the very same surface had taken between 8 and 24 hours to apply and dry out.

According to the above, it is noted that the resin composition of the present invention has been devised to manufacture polymeric concretes, terrazzos and finishes with advantageous setting times, compatibility, durability and maintenance features; it shall also be readily evident for any of ordinary skill in the art that the above embodiments serve illustration purposes only and do not restrict the present invention, as numerous modifications of its details are possible without deviating from the scope of the invention, such as the selection and composition percentage of agents and pigments employed, as well as the filler added thereto when the resin composition is for use in polymeric concretes and terrazzos.

Although specific embodiments of the present invention have been disclosed and exemplified herein, it must be noted that several modifications thereto are possible. Therefore, the present invention shall not be deemed as restricted except for the teachings of the prior art and the scope of the appended claims.

What is claimed is:

1. A polymeric resin composition for the manufacture of coatings comprising:
a) from about 15 to about 50% by weight of methyl methacrylate (MMA) monomer;
b) from about 25 to about 75% by weight of a mixture of equal parts of: i) an isophthalic polyester resin; ii) an orthophthalic polyester resin; and iii) a neopentyl polyester resin;
c) up to about 8% by weight of an epoxy resin obtained from bisphenol A and epichlorohydrin; and,
d) up to about 5% by weight of an aliphatic or aromatic polyurethane resin; the coating manufactured with the composition being a polymeric concrete, terrazzo or finish.

2. A polymeric resin composition for the manufacture of coatings according to claim 1, further comprising at least one of the following agents or compounds:
e) from about 1to about 2% by weight of a polymerization promoter of methacrylic monomers;
f) from about 0.05 to about 0.5% by weight of an inhibitor or stabilizer;
g) from about 0.1 to about 0.5% by weight of a polymerization promoter or activator of polyester resins; and,
h) up to about 1.5% by weight of paraffin.

3. A polymeric resin composition for the manufacture of coatings according to claim 2, wherein said polymerization promoter of methacrylic monomers is selected from the group consisting of N,N-dimethyl-paratoluidine (DMPT), dimethylaniline (DMA), or a mixture thereof.

4. A polymeric resin composition for the manufacture of coatings according to claim 2, wherein said inhibitor or stabilizer is selected from the group consisting of hydroquinone methyl ether, hydroquinone (HQ), dibutyl paracresol or a mixture thereof.

5. A polymeric resin composition for the manufacture of coatings according to claim 2, wherein said polymerization promoter or activator of polyester resins is selected from the group consisting of cobalt naphthenate, cobalt octoate or a mixture thereof.

6. A polymeric resin composition for the manufacture of coatings according to claim 2, further comprising at least one of the following agents or compounds:
i) from about 5 to about 12% by weight of viscosity enhancers;
j) from 3 about to about 10% by weight of a UV-ray protective compound;
k) up to about 8% by weight of ethylene glycol dimethacrylate; and,
l) up to 5% by weight of pigments;
wherein the coating prepared is a polymeric finish.

7. A polymeric resin composition for the manufacture of coatings according to claim 6, wherein said viscosity enhancer is styrene and/or methyl methacrylate monomer.

8. A polymeric resin composition for the manufacture of coatings according to claim 6, wherein said UV-ray protective compound is selected from the group consisting of dibutyl maleate, benzophenone or a mixture thereof.

9. A polymeric resin composition for the manufacture of coatings according to claim 6, further comprises:
m) from about 3 to about 5% by weight of 2-hydroxypropyl-methacrylate.

10. A polymeric resin composition for the manufacture of coatings according to claim 1, wherein the composition is catalyzed with benzoyl peroxide (BOP), methyl ethyl ketone (MEK) or a mixture thereof, with a by weight ratio between the catalyst and the resin composition ranging from about 0.02:1 to about 0.05:1 (catalyst/resin composition).

11. A polymeric resin composition for the manufacture of coatings according to claim 1, wherein said composition has a viscosity from about 8 to about 40 seconds as measured in a Ford No. 4 cup, and a setting time of 0.5 to 2.0 hours.

12. A polymeric resin composition for the manufacture of coatings according to claim 2, wherein the resin composition is mixed with mineral fillers or plastic material fillers, thereby obtaining a polymeric concrete or terrazzo.

13. A polymeric resin composition for the manufacture of coatings according to claim 12, wherein said mineral fillers are silica sands, calcium carbonate, silicon carbide, marble particles, glass, quartz, or a mixture thereof.

14. A polymeric resin composition for the manufacture of coatings according to claim 13, wherein the mineral or plastic filler weight ratio to the resin composition in the polymeric concrete or terrazzo mixture is within the range from about 2:1 to about 6:1 (fillers/resin composition).

15. A polymeric resin composition for the manufacture of coatings according to claim 14, wherein said mineral fillers have a particle size from about 45 μm to about 4 mm.

16. A polymeric resin composition for the manufacture of coatings according to claim 15, wherein for a polymeric terrazzo, said fillers are marble, glass or quartz particles or a mixture thereof and have a particle size from about 45 μm to about 3 mm.
